(19) United States
(12) Patent Application Publication
(10) Pub. No.: US 2025/0213073 A1
(43) Pub. Date: Jul. 3, 2025

(54) Taco Shell Fryer

(71) Applicant: Ivan Manzano, Snowflake, AZ (US)

(72) Inventor: Ivan Manzano, Snowflake, AZ (US)

(21) Appl. No.: 18/397,824

(22) Filed: Dec. 27, 2023

(51) Int. Cl. A47J 43/28

(52) U.S. Cl. CPC A47J 43/283

(57) ABSTRACT

The Taco Tongz is the only product of its kind that is specifically designed to facilitate making homemade tortilla shells. This unprecedented product is uniquely designed to significantly reduce the amount of oil necessary for frying taco shells to provide a more heart healthy alternative, and is carefully crafted with heat resistant, durable materials to ensure long-term sustainability and complete functionality. A Taco Shell Fryer disclosed includes a first taco shell mold and a first extension thereto attached, a second taco shell mold and a second extension thereto attached, a first handle attached to the first taco shell mold via the first extension, a second handle attached to the second taco shell mold via the second extension, and a pivot configured to join the first handle and the second handle and the first extension and the second extension.

### BACKGROUND

For those who enjoy tacos, taking the liberty to fry a crispy taco shell, at home, can be a tedious, time-consuming task which often results in oily uneven shells. As a result, many individuals opt to purchase boxed taco shells instead but store bout shells are prone to break and become stale during storage. There have been no products available as original equipment or as an aftermarket to address this problem.

An apparatus that makes it easier and more efficient in cooking crispy taco shells at home with less oil is not being met by any known device or system at present. There have been no products available as original equipment or as an aftermarket to address this problem either.

### SUMMARY OF THE INVENTION

The main purpose of the Taco Shell Fryer is to provide users with a stand-up taco shell press that facilitates frying the perfect taco shell while utilizing less oil.

A Taco Shell Fryer disclosed includes a first taco shell mold and a first extension thereto attached, a second taco shell mold and a second extension thereto attached, a first handle attached to the first taco shell mold via the first extension, a second handle attached to the second taco shell mold via the second extension, and a pivot configured to join the first handle and the second handle and the first extension and the second extension.

### BRIEF DESCRIPTION OF THE DRAWINGS

FIG. 1 is a left perspective view of the Taco Shell Fryer in a scissor configuration in accordance with an embodiment of the present disclosure.

FIG. 2 is a left perspective view of the Taco Shell Fryer in a salad tong configuration in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

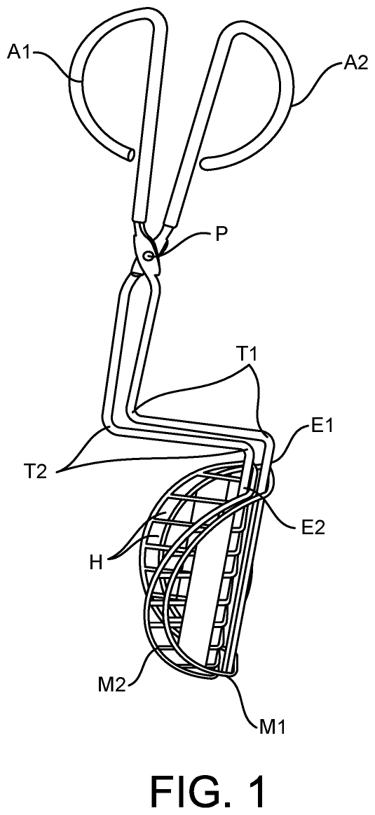

FIG. 1 is a left perspective view of the Taco Shell Fryer in a scissor configuration showing: handle with rubber grips referenced as A1 and A2, scissors pivot referenced as P, heat resistant metal taco shell molds M1 and M2 for forming taco shells, extensions E1 and E2, fry oil drain holes H, and complementary ninety degree bends T1 and T2 in accordance with an embodiment of the present disclosure. The complementary ninety degree bends enable the taco shell molds M1 and M2 to be set in a fryer while the handles are perched on an edge of the fryer out of the frying oil and grease. The result of the two ninety degree bends puts the extensions E1 and E2 in an offset 180 degree relation to the handles A1 and A2.

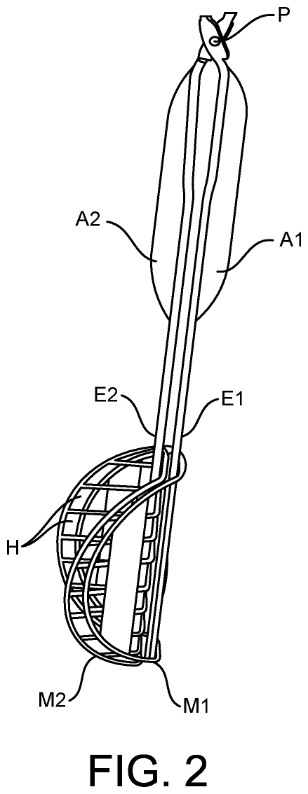

FIG. 2 is a left perspective view of the Taco Shell Fryer in a salad tong configuration accordance with an embodiment of the present disclosure. The view includes handles with rubber grips referenced as A1 and A2, salad tong pivot referenced as P, heat resistant metal taco shell molds M1 and M2 for forming taco shells, extensions E1 and E2 and fry oil drain holes H. Though not depicted for illustrative clarity sake, complementary ninety degree bends are also included in the salad tong embodiment to enable the taco shell molds M1 and M2 to be set in a fryer while the handles are perched on an edge of the fryer out of the frying oil and grease. Therefore, the result of the two ninety degree bends puts the extensions E1 and E2 in an offset 180 degree relation to the handles A1 and A2.

The present disclosed Taco Shell Fryer, also known as “Taco Tongz”, offers a modern cooking utensil that allows users to say good bye to those stale, broken box shells, and eliminated the difficulty associated with frying taco shells, at home. Expanding on the initial design of an average pair of tongs, the Taco Tongz introduces a novel heat resistant metal holder specifically designed to create the crispiest and freshest taco shell. To use Taco Tongz, one would simply open the tortilla mold using the rubber coated scissor-like handle, then center a tortilla shell between the cage-like mold and close the handle. After the tortilla is secured, users can insert the taco mold on its side. Users simply fry each side of the tortilla for thirty seconds to a minute depending on how hot the oil is and the desired crunch factor preferred by the cook. After frying, users can open the Taco Tongz above a plate to release the shell out of the mold and prepare as usual. This innovative, top-quality product provides a quick and easy solution for making taco shells at home by offering the ultimate stand-up taco shell press that functions with less oil; thus, offering a healthy cooking method.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A Taco Shell Fryer comprising:
a first taco shell mold and a first extension thereto attached;
a second taco shell mold and a second extension thereto attached;
a first handle attached to the first taco shell mold via the first extension;
a second handle attached to the second taco shell mold via the second extension; and
a pivot configured to join the first handle and the second handle and the first extension and the second extension.

2. The Taco Shell Fryer of claim 1, wherein the pivot is disposed between the first and the second handle and the first extension and the second extension in a scissor relation setting the first taco shell mold into the second taco shell mold.

3. The taco shell fryer of claim 1, wherein the pivot is disposed distal to the first and the second extension and to the first and the second handle and creates a salad tong relation of the first taco shell mold into the second taco shell mold.

4. The Taco Shell Fryer of claim 1, wherein the first and the second taco shell molds each comprise a wire cage formed in a shape of a hard taco shell.

5. The Taco Shell Fryer of claim 1, further comprising a heat resistant coating on the first handle and the second handle.

6. The Taco Shell Fryer of claim 1, wherein the first and the second extensions comprise 2 each complementary ninety degree bends.

7. The Taco Shell Fryer of claim 1, wherein the first and the second handles each comprise a loop for grasping the respective handle.

8. The Taco Shell Fryer of claim 1, wherein the first and the second handles each comprise a silicone composite padded handle.

9. The Taco Shell Fryer of claim 1, wherein the first and the second handles each comprise a cylindrical grip.

10. The Taco Shell Fryer of claim 1, wherein the first and the second handles and the first and the second extensions are each a one piece wire.

11. The Taco Shell Fryer of claim 1, wherein the first and the second taco shell molds each comprise two half circular sides and an adjoining base.

12. The Taco Shell Fryer of claim 1, wherein the first and the second taco shell molds each comprise two half circular sides set at an non-orthogonal angle to an adjoining base.

13. The Taco Shell Fryer of claim 1, wherein the second taco shell mold is a top mold and the first taco shell mold is a bottom mold.

14. The Taco Shell Fryer of claim 1, wherein the second taco shell mold forms a first side of a taco shell and the first taco shell mold forms a second side.

15. The Taco Shell Fryer of claim 1, wherein the first and the second taco shell molds each define a plurality of frying oil drain holes therein.
